(19) United States
(12) Patent Application Publication
(10) Pub. No.: US 2005/0248727 A1
(43) Pub. Date: Nov. 10, 2005

(54) Projection television

(76) Inventors: Young-jun Jung, Suwon-si (KR); Sung-ik Kim, Suwon-si (KR)

Correspondence Address: STANZIONE & KIM, LLP, 919 18TH STREET, N.W., SUITE 440, WASHINGTON, DC, 20006, US

(21) Appl. No.: 11/123,077

(22) Filed: May 6, 2005

(30) Foreign Application Priority Data
May 8, 2004 (KR) 2004-32519
May 8, 2004 (KR) 2004-32520

(51) Int. Cl. G03B 21/18

(52) U.S. Cl. 353/57

(57) ABSTRACT

A projection television including an optical engine, a circuit spaced apart from and driving the optical engine, a fan placed between the optical engine and the circuit, and blowing cool air to cool down the optical engine and the circuit, and a main cabinet accommodating the optical engine, the circuit and the fan. With this configuration, a projection television with a single fan provided between an optical engine and a circuit to efficiently cool down the optical engine and the circuit, which each generate heat at respectively different temperatures, is provided, and an improved flow passage of cool air to increase cooling efficiency is also provided.

### CROSS-REFERENCE TO RELATED APPLICATIONS

This application claims the benefit of Korean Patent Application Nos. 2004-32519 and 2004-32520 filed on May 8, 2004 in the Korean Intellectual Property Office, the disclosure of which is incorporated herein in its entirety and by reference.

### BACKGROUND OF THE INVENTION

1. Field of the Invention

The present general inventive concept relates to a projection television, and more particularly, to a projection television with an improved cooling system to cool down optical engines and circuits.

2. Description of the Related Art

Generally, a projection television employs an optical device such as a projector, and projects an image beam onto a rear surface of a screen to form an image. The projection television has an advantage of enlarging the screen and thus the image, resulting in an increase in the demand for such a television.

A conventional projection television comprises a cabinet forming an external appearance of the projection television; a screen provided in a front side of the cabinet; a reflection mirror provided in an inner rear portion of the cabinet; an optical engine provided at a bottom portion of the cabinet, and forming and projecting an image beam toward the reflection mirror; a circuit driving the optical engine; and a fan cooling down the optical engine and the circuit.

The optical engine and the circuit of the conventional projection television are closely placed, but the optical engine and the circuit respectively generate heat at different temperatures, and accordingly a plurality of fans are provided to cool down the optical engine and the circuit, respectively. For example, a light source of the optical engine generates heat at a relatively high temperature and therefore needs a fan or fans rotating at a high speed, and a portion of the circuit generates heat at a relatively low temperature and therefore needs a fan or fans rotating at a low speed. Moreover, a flow of cooled air variously changes because the cooled air taken in from an air inlet passes the optical engine and the circuit, etc., until it is emitted through an air outlet.

Accordingly, the conventional projection television has disadvantages of increasing noise due to employing the plurality of fans, increasing manufacturing costs because of a complicated structure, increasing fluctuating noise due to the flow of cooled air, and thereby also decreasing cooling efficiency.

### SUMMARY OF THE INVENTION

Accordingly, it is an aspect of the present general inventive concept to provide a projection television with a single fan provided between an optical engine and a circuit to efficiently cool down the optical engine and the circuit generating the heat at respectively different temperatures, and an improved flow passage of cooled air to increase cooling efficiency.

Additional aspects and/or advantages of the present general inventive concept will be set forth in part in the description which follows and, in part, will be obvious from the description, or may be learned by practice of the general inventive concept.

The foregoing and other aspects and advantages of the present general inventive concept are achieved by providing a projection television comprising an optical engine; a circuit spaced from and driving the optical engine; a fan provided between the optical engine and the circuit, and blowing cooled air to cool down the optical engine and the circuit; and a main cabinet accommodating the optical engine, the circuit and the fan.

According to an aspect of the present general inventive concept, the projection television may further comprise a fan supporting unit placed between the optical engine and the circuit, and supporting unit supporting the fan and partitioning the main cabinet.

According to an aspect of the present general inventive concept, the fan supporting unit comprises a fan holder supporting an edge of the fan; and a fan supporter comprising an through hole through which the cooled air passes, and supporting the fan holder and partitioning the main cabinet.

According to an aspect of the present general inventive concept, the fan blows the cooled air from the circuit toward the optical engine.

According to an aspect of the present general inventive concept, the optical engine may be placed above the circuit.

According to an aspect of the present general inventive concept, the main cabinet may comprise an air inlet in a bottom surface thereof adjacent to the circuit to take in the cooled air from an outside.

According to an aspect of the present general inventive concept, the main cabinet may further comprise a cabinet stand separately supporting the bottom surface of the main cabinet at a given distance from an installation surface.

According to an aspect of the present general inventive concept, the main cabinet may function as a duct introducing the cooled air taken in from the air inlet to flow upward to sequentially cool down the circuit and the optical engine.

### BRIEF DESCRIPTION OF THE DRAWINGS

These and/or other aspects and advantages of the present general inventive concept will become apparent and more readily appreciated from the following description of the embodiments, taken in conjunction with the accompany drawings of which:

FIG. 1 is a perspective view of a projection television according to an embodiment of the present general inventive concept;

FIG. 2 is a sectional view of the project television of FIG. 1, taken along the line II-II;

FIG. 3 is a perspective view of a rear side of a main cabinet of the projection television in FIG. 1; and

FIG. 4 illustrates where the fan is combined with the main cabinet in FIG. 3; and

FIG. 5 is a perspective view of the fan in FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

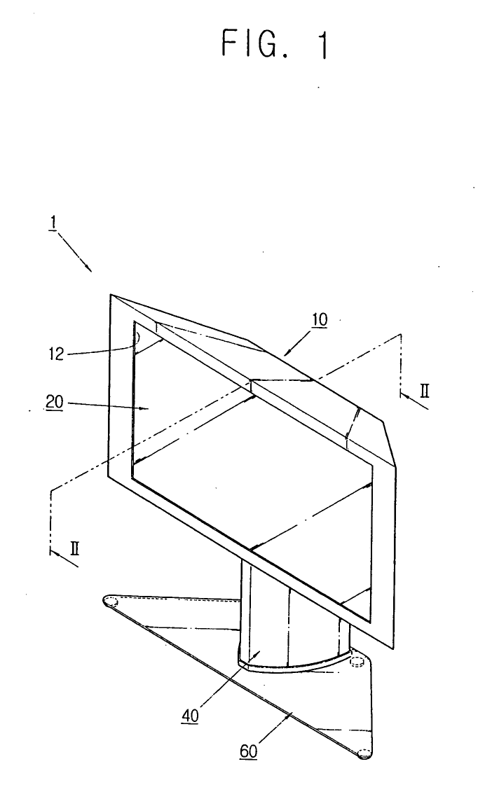

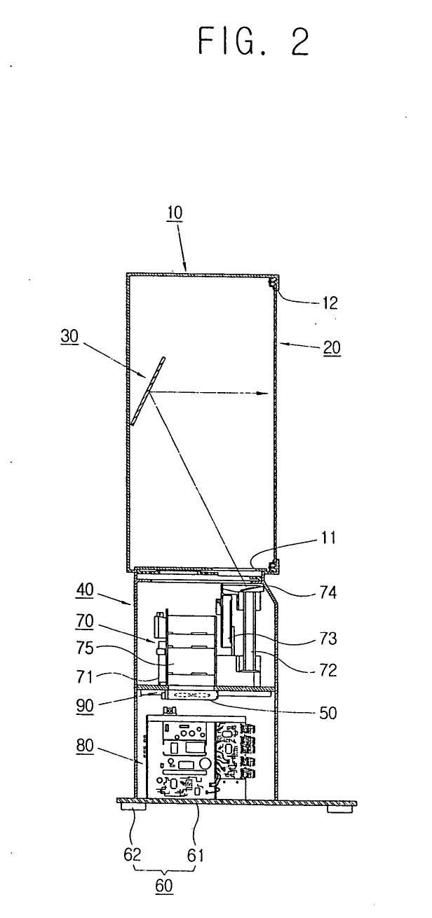

As shown in FIGS. 1 and 2, a projection television 1 according to an embodiment of the present general inventive concept comprises an optical engine 70 forming and projecting an image beam; a circuit 80 spaced from and driving the optical engine 70; a fan 50 provided between the optical engine 70 and the circuit 80, and respectively cooling down the optical engine 70 and the circuit 80; and a main cabinet 40 accommodating the optical engine 70, the circuit 80 and the fan 50. Further, the projection television 1 comprises a fan supporting unit 90 placed between the optical engine 70 and the circuit 80, and partitioning the main cabinet 40 to separately accommodate the optical engine 70 and the circuit 80. In addition, the projection television 1 further comprises a reflection mirror 30 reflecting the image beam projected from the optical engine 70; a screen 20 visualizing the image beam reflected by the reflection mirror 30 to an image; and a screen cabinet 10 to which the screen 20 and the reflection mirror 10 are accommodated.

An opening 12 is provided in a front side of the screen cabinet 10, and thus the screen 20 can be exposed outward therethrough, and the reflection mirror 30 is disposed at an inner rear portion of the screen cabinet 10 to reflect the image beam projected from the optical engine 70 to the screen 20. In addition, at a bottom side of the screen cabinet 10, a predetermined size of a projection hole 11 is provided so that the image beam from the optical engine 70 can be projected therethrough to the reflection mirror 70.

The optical engine 70 may comprise a light source 71 emitting light; a color filter wheel (not shown) filtering the light emitted from the light source 71; an illuminator 72 converting the light passing through the color filter wheel into evenly parallel light and focusing the parallel light; a display device 73 visualizing the light from the illuminator 72 to the image; a projector lens 74 projecting the image beam containing the image visualized by the display device in large scale; and a ballast 75 providing power to the optical engine 70.

The circuit 80 drives the optical engine to form the image beam based on image signal information transmitted externally through an antenna or a cable, etc., or transmitted through multimedia devices such as a DVD, VCR, or a computer, etc.

The fan 50 employs an axial flow fan blowing air along an axial direction to control cooled air to flow from the circuit 80 toward the optical engine 70, and accordingly cooling efficiency can be increased as the cooled air flows from the circuit 80 generating heat at relatively low temperature to the optical 70 engine generating the heat at relatively high temperature.

The light source 71 of the optical engine 70 is preferably, but not necessarily, placed close to the fan 50 since it generates the heat at a higher temperature.

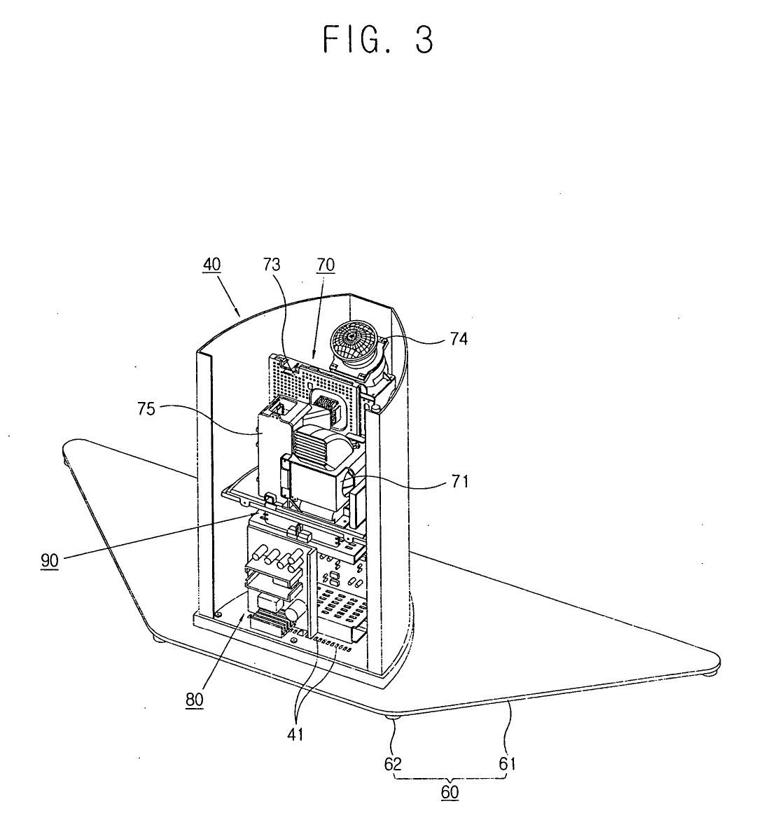

As shown in FIG. 3, the main cabinet 40 is divided into an upper portion and a lower portion, and it is preferable, but not necessary, that the optical engine 70 is accommodated in the upper portion while the circuit 80 is accommodated in the lower portion. Also, an air inlet 41 is preferably but not necessarily, provided in a bottom surface of the main cabinet 40 to take in the cool air from an outside. Thus, the cooled air taken in from the bottom surface of the main cabinet 40 is smoothly ascended to thereby cool down the circuit 80 generating the heat at relatively low temperature at first, and then smoothly ascended to cool down the optical engine 70 generating heat at a relatively high temperature, and thereby increasing an overall cooling efficiency.

Further, the main cabinet 40 preferably, but not necessarily, comprises a cabinet stand 60 supporting the main cabinet 40 at a given distance from an installation surface, to smoothly take in the cooled air from the outside through the air inlet 41 provided in the bottom surface of the main cabinet 40. The cabinet stand 60 comprises a main supporter 61 supporting the lower portion of the main cabinet 40, and a leg 62 separately supporting the main supporter 61 from the installation surface.

Here, the main cabinet 40 may function as a duct conducting the cool air taken in from the bottom surface thereof to flow upward and sequentially cool down the circuit 80 and the optical engine 70. Thus, the cool air smoothly ascends while cooling down the circuit 80 first and then the optical engine 70, resulting in increasing cooling efficiency.

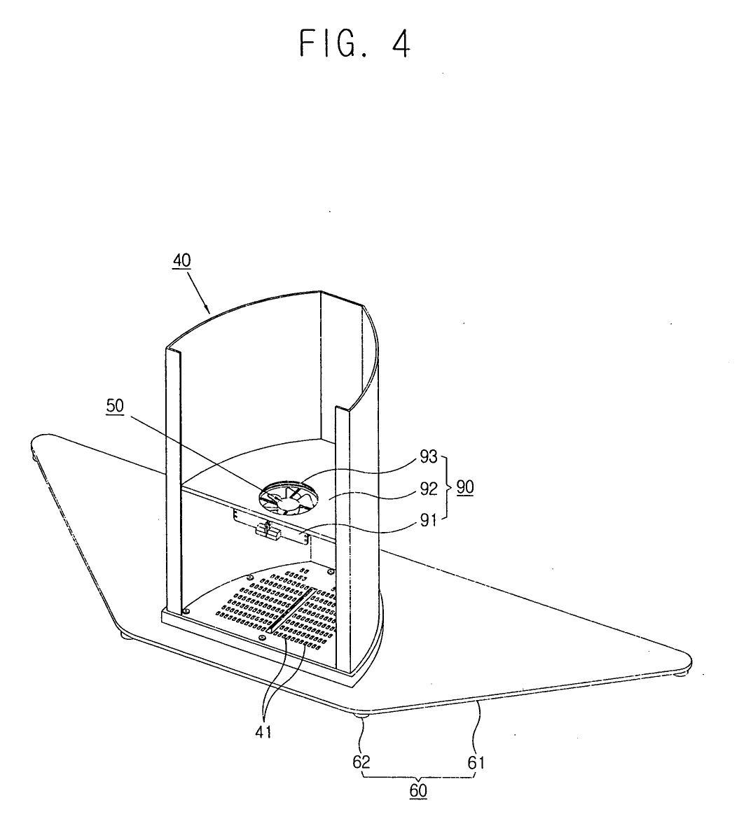

As shown in FIG. 4, the fan supporting unit 90 comprises a fan holder 91 holding an edge of the fan 50, and a fan supporter 92 supporting the fan holder 91, partitioning the main cabinet 91 into an upper portion and a lower portion, and comprising a through hole 93. Thus, the cool air flows from the lower portion to the upper portion of the main cabinet 40 by passing through the through hole 93 of the fan supporter 92.

Herein, the through hole 93 may be provided in a center portion of the fan supporter 92, and the fan holder 91 is therefore detachably coupled to the center portion in which the through hole 93 of the fan supporter 92 is formed. However, the through hole 93 may be placed at any position along the fan supporter 92 which provides the intended cooling effect described herein, and the fan holder 91 can be positioned accordingly.

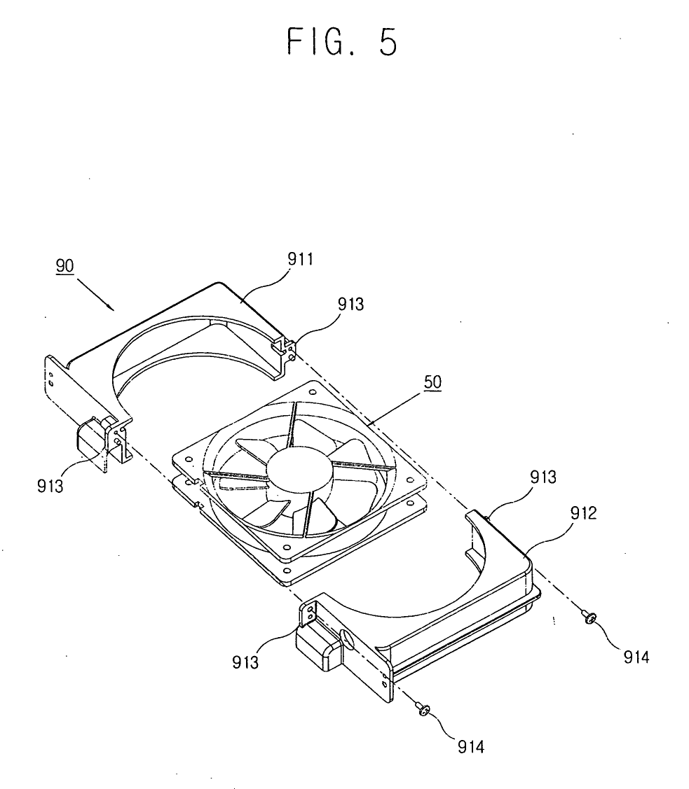

The fan holder 91, as shown in FIG. 5, may comprise a left holder 911 and a right holder 912, which are coupled together forming a predetermined accommodating space, in which the edge of the fan 50 is supportably accommodated therein. The left holder 911 and the right holder 912 of the fan holder 91 may respectively comprise flanges 913 having a coupling hole, and the respective flanges 913 of the left holder 911 and the right holder 912 may be coupled together by a screw 914. However, alternative methods of coupling the respective flanges 913 together may be used.

Unlike the above embodiment, the air inlet 41 may not be necessarily provided in the bottom surface of the main cabinet 40. It may be provided in at least a side of the bottom portion of the main cabinet 40, in which the circuit 80 is accommodated.

Also, the fan supporter 92 may divide the main cabinet 40 into a left portion and a light portion instead of the upper portion and the lower portion, and thus the circuit 80 and the optical engine 70 may be accommodated respectively in the left portion and the right portion, or vice versa.

With the above configuration, function and effect of the projection television 1 according to an embodiment of present general inventive concept are as follows.

The fan 50 placed between the optical engine 70 and the circuit 80 blows the cool air from the circuit 80 toward the optical engine 70, thereby efficiently cooling down the optical engine 70 generating heat at relatively high temperature and the circuit 80 generating heat at relatively low temperature. Further, according to the heat transfer theory, the cooling efficiency can be increased by placing the optical engine 70 generating heat at a relatively high temperature in the upper portion of the main cabinet 40 and the circuit 80 generating heat at a relatively low temperature in the lower portion of the main cabinet 40, considering that the cool air is directed from the bottom portion to the upper portion of the main cabinet 40 by the fan 50.

Moreover, the air inlet 41 is provided in the bottom surface of the main cabinet 40, and thus cool air is taken in therethrough and cools down the circuit 80, and then passes through the fan 50 and cools down the optical engine 70, and then is emitted externally. Therefore, a flow of cool air can be simplified, resulting in increasing an overall cooling efficiency.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A projection television comprising:
an optical engine;
a circuit spaced apart from and driving the optical engine;
a fan provided between the optical engine and the circuit, and blowing cool air to cool down the optical engine and the circuit; and
a main cabinet accommodating the optical engine, the circuit and the fan.

2. The projection television according to claim 1, further comprising a fan supporting unit placed between the optical engine and the circuit and supporting the fan and partitioning the main cabinet.

3. The projection television according to claim 2, wherein the fan supporting unit comprises:
a fan holder supporting an edge of the fan; and
a fan supporter comprising a through hole through which the cool air passes, and supporting the fan holder and partitioning the main cabinet.

4. The projection television according to claim 1, wherein the fan blows the cool air from the circuit toward the optical engine.

5. The projection television according to claim 1, wherein the optical engine is placed above the circuit.

6. The projection television according to claim 5, wherein the main cabinet comprises an air inlet in a bottom surface thereof adjacent to the circuit to take in the cool air from an outside.

7. The projection television according to claim 6, wherein the main cabinet further comprises a cabinet stand separately supporting the bottom surface of the main cabinet at a given distance from an installation surface.

8. The projection television according to claim 6, wherein the main cabinet may function as a duct introducing the cool air taken in through the air inlet to flow upward to sequentially cool down the circuit and the optical engine.

9. The projection television according to claim 2, wherein the optical engine is placed above the circuit.

10. The projection television according to claim 9, wherein the main cabinet comprises an air inlet in a bottom surface thereof adjacent to the circuit to take in the cool air from an outside.

11. The projection television according to claim 10, wherein the main cabinet further comprises a cabinet stand separately supporting the bottom surface of the main cabinet at a given distance from an installation surface.

12. The projection television according to claim 10, wherein the main cabinet may function as a duct introducing the cool air taken in through the air inlet to flow upward to sequentially cool down the circuit and the optical engine.

13. The projection television according to claim 2, wherein the optical engine is placed above the circuit.

14. The projection television according to claim 13, wherein the main cabinet comprises an air inlet in a bottom surface thereof adjacent to the circuit to take in the cool air from an outside.

15. The projection television according to claim 14, wherein the main cabinet further comprises a cabinet stand separately supporting the bottom surface of the main cabinet at a given distance from an installation surface.

16. The projection television according to claim 14, wherein the main cabinet may function as a duct introducing the cool air taken in through the air inlet to flow upward to sequentially cool down the circuit and the optical engine.

17. The projection television according to claim 4, wherein the optical engine is placed above the circuit.

18. The projection television according to claim 17, wherein the main cabinet comprises an air inlet in a bottom surface thereof adjacent to the circuit to take in the cool air from an outside.

19. The projection television according to claim 18, wherein the main cabinet further comprises a cabinet stand separately supporting the bottom surface of the main cabinet at a given distance from an installation surface.

20. The projection television according to claim 18, wherein the main cabinet may function as a duct introducing the cool air taken in through the air inlet to flow upward to sequentially cool down the circuit and the optical engine.

21. A projection television comprising:
a main cabinet;
at least two heat generating components within the cabinet to generate heat;
a cooling unit within the cabinet to cool each of the heat generating components by directing cool air toward each of the at least two heat generating components one at a time in an order corresponding to the amount of heat generated therefrom.

22. The projection television according to claim 21, wherein the cooling unit is a fan.

23. The projection television according to claim 21, further comprising a main cabinet accommodating each of the heat generating components and the cooling unit therein.

24. The projection television according to claim 21, wherein the heat generating components are positioned above each other in an order corresponding to the amount of heat generated therefrom.

25. The projection television according to claim 24, wherein the main cabinet comprises an air inlet in a bottom surface thereof adjacent to the heat generating component which generates the lowest amount of heat to take in the cool air from outside the main cabinet.

26. The projection television according to claim 21, further comprising a cooling unit support member positioned between each pair of the at least two heat generating components to support the cooling unit and partition the cabinet into separate partitions containing a respective heat generating component.
